(19) United States
(12) Patent Application Publication
(10) Pub. No.: US 2016/0160317 A1
(43) Pub. Date: Jun. 9, 2016

(54) METHOD AND SYSTEM FOR REMOVING SILICA FROM AN ORE

(71) Applicant: Sesa Sterlite Limited, Odisha (IN)

(72) Inventors: Mukesh KUMAR, New Delhi (IN); Bimalananda SENAPATI, Kolkata (IN); Chikkala Sateesh KUMAR, Andhra Pradesh (IN)

(21) Appl. No.: 14/659,353

(22) Filed: Mar. 16, 2015

(30) Foreign Application Priority Data
Dec. 6, 2014 (IN) 1272/KOL/2014

(51) Int. Cl. C22B 21/00; B03B 9/00; B03B 5/34; B03B 7/00; C22B 3/12; C22B 3/18

(52) U.S. Cl. CPC C22B 21/0015; C22B 3/12; C22B 3/18; B03B 5/34; B03B 7/00; B03B 9/00

(57) ABSTRACT

The present disclosure provides a beneficiation arrangement for removing silica from an ore. The beneficiation arrangement includes one or more scrubbing arrangements to scrub the ore with a stream of a washing fluid and recover the silica, one or more screening arrangements to perform screening of the scrubbed ore to extract a first quantity of recovered ore and an underflow, and one or more separating arrangements to enable separation of at least silica particles from the underflow. The one or more separating arrangements include one or more cyclonic separating arrangements to cyclonically separate the silica particles into one or more ranges of sizes of the silica particles from the underflow, and one or more filter press arrangements to perform pressure filtration on a recovered ore extract mix of the one or more recovered ore extract mix.

### TECHNICAL FIELD

The present invention relates to the field of treating an ore, and in particular relates to removing silica from the ore.

### BACKGROUND

In an emerging era of excessive industrialization, a need for effective utilization and minimum wastage of natural resources exists. Nowadays, there is a growing emphasis on minimizing the wastage of the natural resources, particularly during extraction of minerals. There are various existing industrial processes which enables the extraction of minerals from ores. However, most of these existing industrial processes do not extract minerals properly from the ores, thereby resulting in higher cost of overall extraction. For example, in one of industrial processes, silica particles are required to be economically removed from bauxite/laterite to extract alumina in Bayer's process. The silica particles are removed so as to reduce the caustic consumption and thereby to reduce the overall cost of the extraction process.

The effective removal of the silica from the bauxite/laterite depends on a ratio based on quantities of alumina and silica present in the bauxite/laterite. Generally, the bauxite/laterite with the alumina-silica ratio of more than 10 is processed without any difficulty. However, the bauxite/laterite with the alumina-silica ratio less than 10 is difficult to process and leads to increased cost of extraction. Further, an inefficient removal of the silica from the bauxite/laterite leads to formation of insoluble sodium alumino silicate which gets separated from the extraction process, thereby entailing loss of valuable caustic soda and the alumina. The alumina goes along with the red-mud and is a major waste generated from alumina refinery. In addition, the loss of the caustic soda and the alumina leads to wastage of commercial industrial products.

Currently, various methods and systems exist that separates the silica from the bauxite/laterite. The present methods and systems reduce the silica content in the bauxite/laterite in a range of 10 to 20 percent. Further, these methods and systems recover the de-silicated bauxite/laterite with high moisture contents. Furthermore, many of these methods and systems are unable to reduce reactive silica content effectively from the bauxite/laterite.

In light of the above stated discussion, there is a need for a method and system that overcomes the above stated disadvantages. Further, there is a need for a method and system that economically separates the reactive silica content from the bauxite/laterite.

### SUMMARY

In an aspect of the present disclosure, a beneficiation arrangement for removing silica from an ore is provided. The beneficiation arrangement includes one or more scrubbing arrangements to scrub the ore with a stream of a washing fluid and recover the silica from the ore, one or more screening arrangements to perform screening of the scrubbed ore to extract a first quantity of recovered ore and an underflow, and one or more separating arrangements to enable separation of at least silica particles from the underflow. The first quantity of recovered ore is in a range of 88-95 percent of the ore. The one or more separating arrangements extract one or more quantities of recovered ore in the range of 88-95 percent of the ore. Further, the one or more separating arrangements include one or more cyclonic separating arrangements to cyclonically separate the silica particles into one or more ranges of sizes of the silica particles from the underflow and recover one or more recovered ore extract mix, and one or more filter press arrangements to perform pressure filtration on a recovered ore extract mix of the one or more recovered ore extract mix received from a cyclonic separating arrangement of the one or more cyclonic separating arrangements. The one or more filter press arrangements recover a second quantity of recovered ore by the performing of the pressure filtration on the recovered ore extract mix and size of the ore particles of the recovered ore extract mix is in a range of 0.5 millimeters to 10 microns. The size of the ore particles in the underflow is in a range of −3 millimeters to 0.5 millimeters.

In an embodiment of the present disclosure, the beneficiation arrangement further includes a first de-watering arrangement to perform de-watering of a recovered ore extract mix of the one or more recovered ore extract mix from a cyclonic separating arrangement of the one or more cyclonic separating arrangements. The first de-watering arrangement recovers a third quantity of recovered ore.

In another embodiment of the present disclosure, the one or more cyclonic separating arrangements produce a mixture including a pre-determined range of size of silica particles and the silica particles of the pre-determined range of size is recovered from the mixture by utilizing bio-leaching.

In yet another embodiment of the present disclosure, the beneficiation arrangement further includes a re-slurring arrangement to perform re-slurring of the second quantity of recovered ore with caustic liquor.

In yet another embodiment of the present disclosure, the beneficiation arrangement further includes one or more grinding arrangements to grind the first quantity of recovered ore and the third quantity of recovered ore with a caustic liquor and reduce size of the first quantity of recovered ore from 40-25 millimeters to 1.2 millimeters and size of the third quantity of recovered ore from 3 millimeters to 1.2 millimeters.

In yet another embodiment of the present disclosure, a first scrubbing arrangement of the one or more scrubbing arrangements and a first screening arrangement of the one or more screening arrangements extract the first quantity of recovered ore having size in a range of 40-20 millimeters to +0.5 millimeters.

In yet another embodiment of the present disclosure, a second scrubbing arrangement of the one or more scrubbing arrangements and a second screening arrangement of the one or more screening arrangements extract the first quantity of recovered ore, the second quantity of recovered ore having size in a range of −45 microns to +10 microns and the third quantity of recovered ore having size in a range of −3 millimeters to +45 microns.

In yet another embodiment of the present disclosure, the beneficiation arrangement further includes a filtrate collecting arrangement to collect a filtrate generated from the removal of silica from the ore.

In yet another embodiment of the present disclosure, the beneficiation arrangement further includes a second de-watering arrangement to perform de-watering of the one or more recovered ore extract mix to extract the one or more quantities of recovered ores.

In yet another embodiment of the present disclosure, the beneficiation arrangement further includes one or more thickening arrangements to facilitate thickening of the one or more recovered ore extract mix to extract the one or more quantities of recovered ores.

In another aspect of the present disclosure, method for removing silica from an ore is provided. The method includes scrubbing the ore with a stream of a washing fluid to remove silica, screening the scrubbed ore to extract a first quantity of recovered ore and an underflow, and enabling separation of at least silica particles from the underflow. The separation of silica particles extracts one or more quantities of recovered ore. The enabling includes separating the silica particles into one or more ranges of sizes of the silica particles from the underflow and performing pressure filtration on a recovered ore extract mix of the one or more recovered ore extract mix from a cyclonic separating arrangement of the one or more cyclonic separating arrangements. The separating recovers one or more recovered ore extract mix by utilizing one or more cyclonic separating arrangements and size of the ore particles in the underflow is in a range of −3 millimeter to 0.5 millimeter. The performing of the pressure filtration on the recovered ore extract mix recovers a second quantity of recovered ore and size of ore particles of the recovered ore extract mix is in a range of 0.5 millimeter to 10 micron. The first quantity of recovered ore and the one or more quantities of recovered ore is in a range of 88-95 percent of the ore, and wherein the method reduces silica in the ore in a range of 20-50 percent.

In an embodiment of the present disclosure, the method further includes de-watering a recovered ore extract mix of the one or more recovered ore extract mix from a cyclonic separating arrangement of the one or more cyclonic separating arrangements. The de-watering of the recovered ore extract mix recovers a third quantity of recovered ore.

In another embodiment of the present disclosure, the scrubbing and the screening extract the first quantity of recovered ore having size in a range of 40-20 millimeters to +0.5 millimeters by utilizing a first scrubbing arrangement and a first screening arrangement.

In yet another embodiment of the present disclosure, the scrubbing and the screening extract the first quantity of recovered ore, the second quantity of recovered ore having size in a range of −45 microns to +10 microns and the third quantity of recovered ore having size in a range of −3 millimeters to +45 microns by utilizing a second scrubbing arrangement and a second screening arrangement.

In yet another embodiment of the present disclosure, a moisture content in the first quantity of recovered ore is in a range of 6 percent to 10 percent, a moisture content in the second quantity of recovered ore is in a range of 10 percent to 15 percent and a moisture content in the third quantity of recovered ore is in a range of 20 percent to 25 percent.

In yet another embodiment of the present disclosure, the method further includes performing de-watering of the one or more recovered ore extract mix to extract the one or more quantities of recovered ores.

In yet another aspect of the present disclosure, a method for removing silica from an aluminium ore is provided. The method includes screening the aluminium ore to extract a first quantity of recovered ore and an underflow, and facilitating separation of at least silica particles from the underflow. The aluminium ore is scrubbed with a stream of a washing fluid and the screening is performed in a beneficiation arrangement to remove the silica. The separation of silica particles extracts one or more quantities of recovered ore and the facilitating includes cyclonically separating the silica particles into one or more ranges of sizes of the silica particles from the underflow to recover one or more recovered ore extract mix by utilizing one or more cyclonic separating arrangements, and performing pressure filtration on a recovered ore extract mix of the one or more recovered ore extract mix from a cyclonic separating arrangement of the one or more cyclonic separating arrangements. Size of the aluminium ore particles in the under-flow is in a range of −3 millimeters to 0.5 millimeters. The performing of the pressure filtration on the recovered ore extract mix recovers a second quantity of recovered ore and size of the aluminium ore particles of the recovered ore extract mix is in a range of 0.5 millimeter to 10 micron. The first quantity of recovered ore and the one or more quantities of recovered ore is in a range of 88-95 percent of the aluminium ore and the method reduces silica in the aluminium ore in a range of 20-50 percent.

In an embodiment of the present disclosure, the method further includes grinding the first quantity of recovered ore and the third quantity of recovered ore with caustic liquor. The grinding reduces size of the first quantity of recovered ore from 40-25 millimeters to 1.2 millimeters and size of the third quantity of recovered ore from 3 millimeters to 1.2 millimeters.

In another embodiment of the present disclosure, the method includes collecting a filtrate generated from the removal of the silica from the aluminium ore.

In yet another embodiment of the present disclosure, the aluminium ore is one of a bauxite and a laterite.

### BRIEF DESCRIPTION OF THE FIGURES

Having thus described the invention in general terms, reference will now be made to the accompanying drawings, which are not necessarily drawn to scale, and wherein:

FIG. 1 illustrates a system for removing silica from an ore, in accordance with various embodiments of the present disclosure;

FIG. 2A illustrates various functional components of a beneficiation arrangement, in accordance with an embodiment of the present disclosure;

FIG. 2B illustrates various functional components of the beneficiation arrangement in detail, in accordance with an embodiment of the present disclosure;

FIG. 3A illustrates functional components of the beneficiation arrangement, in accordance with another embodiment of the present disclosure;

FIG. 3B illustrates functional components of the beneficiation arrangement in detail, in accordance with another embodiment of the present disclosure;

FIG. 4A illustrates functional components of the beneficiation arrangement, in accordance with yet another embodiment of the present disclosure;

FIG. 4B illustrates functional components of the beneficiation arrangement in detail, in accordance with yet another embodiment of the present disclosure;

FIG. 5 illustrates a flowchart for removing the silica from the ore, in accordance with an embodiment of the present disclosure;

FIG. 6 illustrates a flowchart for facilitating separation of silica particles from an underflow, in accordance with the embodiment of the present disclosure;

FIG. 7 illustrates a flowchart for removing the silica from the ore, in accordance with another embodiment of the present disclosure; and

FIG. 8 illustrates a flowchart for facilitating the separation of the silica particles from the underflow, in accordance with another embodiment of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

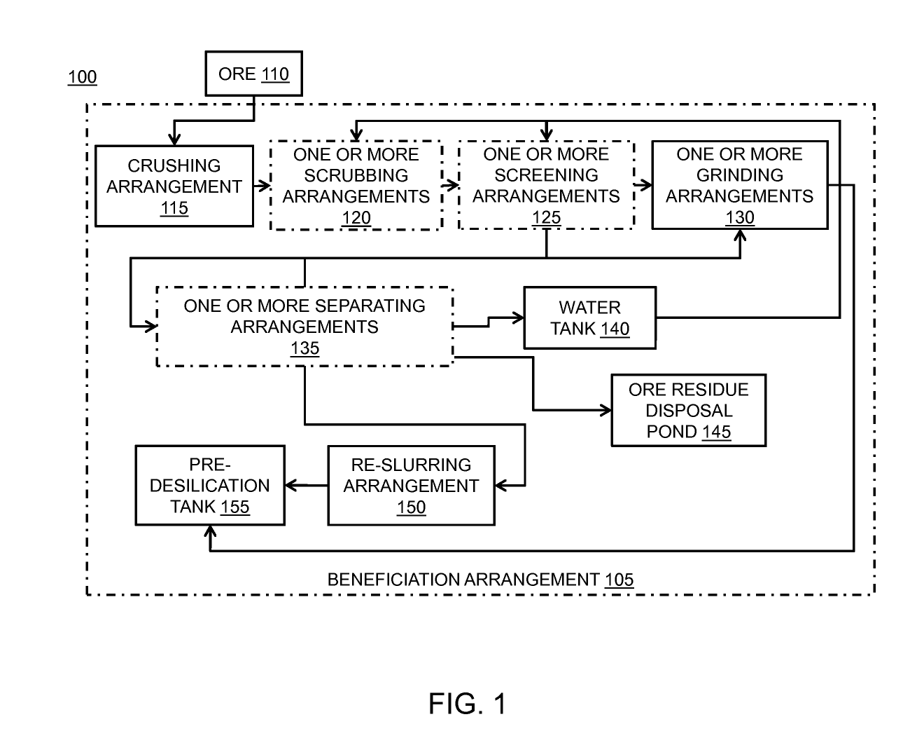

FIG. 1 illustrates a system 100 for removing silica from an ore, in accordance with various embodiments of the present disclosure. Examples of the ore include one of a hydrated aluminium ore (bauxite with associated impurities including silica, iron oxide, titanium oxide, etc.) and a laterite ore. In an embodiment of the present disclosure, the ore is recovered by removing the silica. The silica is a chemical compound and its presence in the ore consumes caustic by forming soda-lite. The system 100 includes a beneficiation arrangement 105.

In an embodiment of the present disclosure, the beneficiation arrangement 105 is a bauxite/laterite beneficiation apparatus utilized for separating the silica from the ore. The beneficiation arrangement 105 includes a crushing arrangement 115 for crushing an ore 110, one or more scrubbing arrangements 120, one or more screening arrangements 125, one or more grinding arrangements 130, one or more separating arrangements 135, a water tank 140, a ore residue disposal pond 145, a re-slurring arrangement 150 and a pre-desilication tank 155.

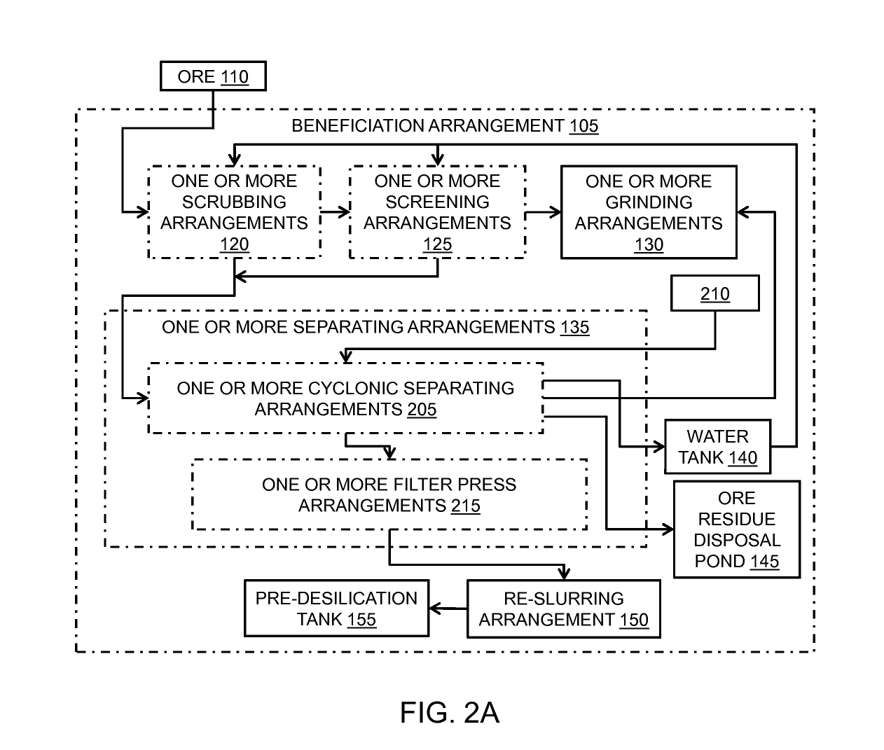

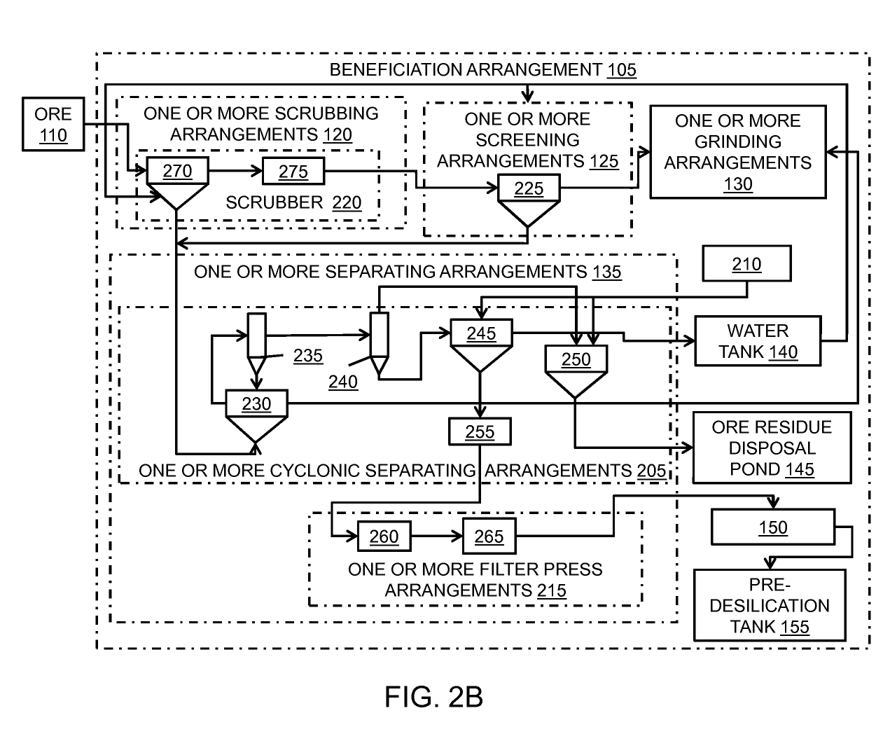

The crushing arrangement 115 crushes the ore 110 to obtain finer ore particles and remove oversized impurities from the ore 110. The finer ore particles pass to the one or more scrubbing arrangements 120. The one or more scrubbing arrangements 120 scrub the finer ore particles with a stream of a washing fluid to remove surface silica present on the finer ore particles. The one or more screening arrangements 125 perform screening of the scrubbed ore to extract a first quantity of recovered ore and an underflow. The screening arrangement 110 performs screening by washing the scrubbed ore with the stream of the washing fluid followed by de-watering of the scrubbed ore. The screened ore having low silica content and high content of the ore particles is passed to the one or more grinding arrangements 130. Each of the one or more grinding arrangements 130 includes a ball mill grinder that performs wet grinding of the screened ore having the low silica content (as exemplarily described in detailed description of FIG. 2B). The one or more grinding arrangements 130 send the grinded ore to the pre-desilication tank 155. The pre-desilication tank 155 stores the grinded ore. In an embodiment of the present disclosure, the grinded ore is the first quantity of recovered ore. However, the underflow of the one or more screening arrangements 125 includes the screened ore having finer silica particles.

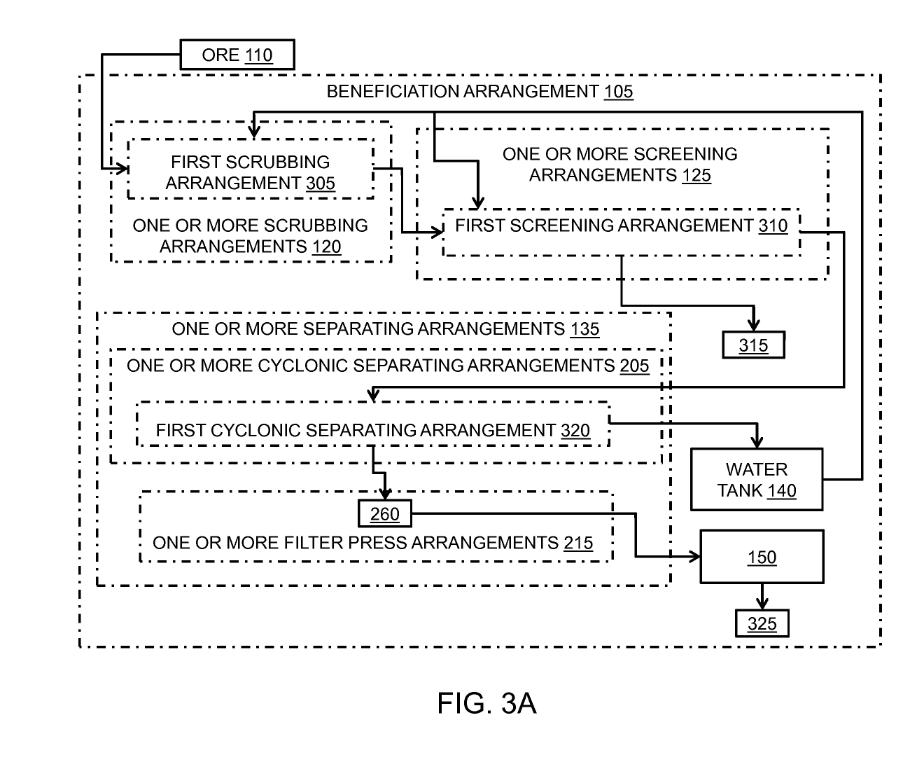

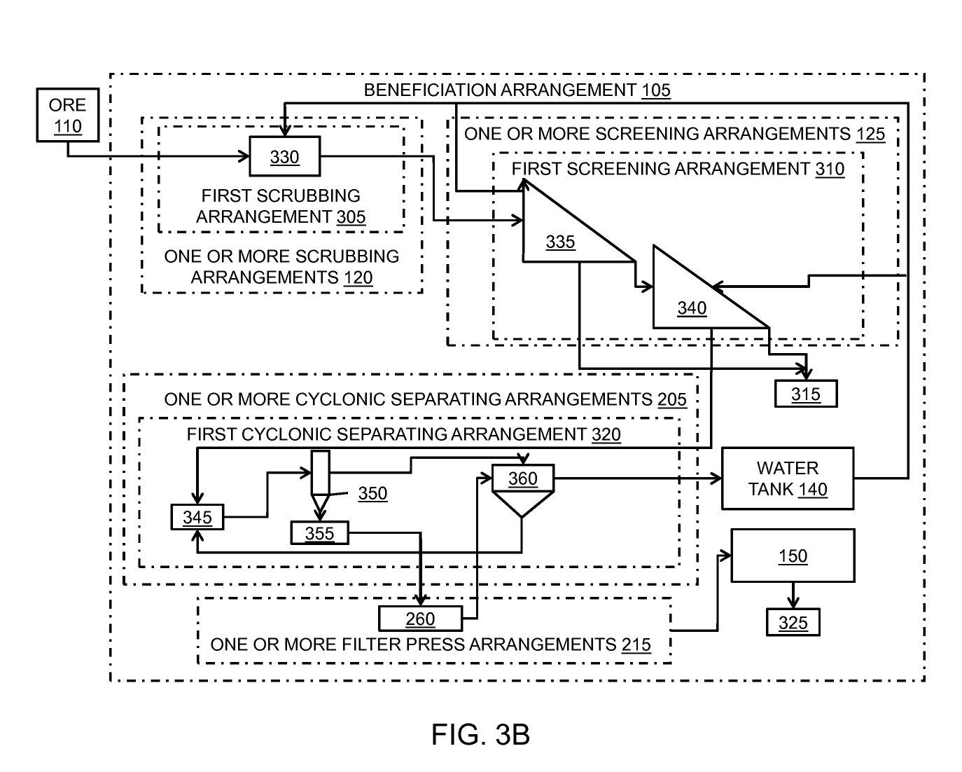

The underflow is fed to the one or more separating arrangements 135. In an embodiment of the present disclosure, size of ore particles in the underflow is in a range of −3 millimeters to 0.5 millimeters. Further, the beneficiation arrangement 105 enables separation of at least silica particles from the underflow to extract one or more quantities of recovered ore by utilizing the one or more separating arrangements 135. The one or more separating arrangements 135 cyclonically separate the silica particles into one or more ranges of sizes of the silica particles from the underflow. Further, the one or more separating arrangements 135 recover one or more recovered ore extract mix (as illustrated in detailed description of FIG. 2B and FIG. 3B). The water tank 140 collects the washing fluid from the one or more separating arrangements 135. The washing fluid collected in the water tank 140 can be used in the scrubbing and the screening of the ore 110.

A sludge having the silica particles is disposed off from the one or more separating arrangements 135 into the ore residue disposal pond 145. A quantity of recovered ore from the one or more quantities of recovered ore passes to the one or more grinding arrangements 130. However, other quantities of recovered ore from the one or more quantities of recovered ore pass to the re-slurring arrangement 150. The re-slurring arrangement 150 passes the re-slurred quantities of recovered ore to the pre-desilication tank 155 where it is stored. In an embodiment of the present disclosure, the first quantity of recovered ore and the one or more quantities of recovered ore is in a range of 88 to 95 percent of the ore and reduced silica content in the ore 110 is in a range of 20 to 50 percent.

It may be noted that in FIG. 1, the pre-desilication tank 155 is utilized for storing the re-slurred quantities of recovered ore; however those skilled in the art would appreciate that more number of pre-desilication tanks can be utilized for storing the re-slurred quantities of recovered ore.

FIG. 2A illustrates various functional components of the beneficiation arrangement 105, in accordance with an embodiment of the present disclosure. It may be noted that to explain the functional elements of FIG. 2A, references will be made to the functional elements of FIG. 1. The FIG. 2A includes one or more cyclonic separating arrangements 205, one or more flocculants 210 and one or more filter press arrangements 215. The one or more cyclonic separating arrangements 205 and one or more filter press arrangements 215 are functional components of the one or more separating arrangements 135.

As, described in detailed description of FIG. 1, the one or more scrubbing arrangements 120 scrub the ore 110 with the stream of the washing fluid to remove the surface silica. The one or more screening arrangements 125 perform the screening of the scrubbed ore to extract the first quantity of recovered ore and the underflow. The screened ore having the low silica content and high content of the ore particles is passed to the one or more grinding arrangements 130 (as described in detailed description of FIG. 1). Each of the one or more grinding arrangements 130 includes the ball mill grinder that performs wet grinding of the screened ore having the low silica content (as exemplarily described in detailed description of FIG. 2B). The one or more grinding arrangements 130 send the grinded ore to the pre-desilication tank 155. In an embodiment of the present disclosure, the grinded ore is the first quantity of recovered ore. However, an underflow of the one or more scrubbing arrangements 120 and the underflow of the one or more screening arrangements 125 include the finer silica particles of the ore 110.

The underflow is fed to the one or more separating arrangements 135. In an embodiment of the present disclosure, the underflow is a combined underflow of the one or more scrubbing arrangements 120 and the one or more screening arrangements 125. In another embodiment of the present disclosure, size of ore particles in the underflow is in a range of −3 millimeters to 0.5 millimeters. Further, the beneficiation arrangement 105 enables the separation of the at least silica particles from the underflow to extract the one or more quantities of recovered ore by utilizing the one or more separating arrangements 135. The one or more cyclonic separating arrangements 205 cyclonically separate the silica particles into the one or more ranges of the sizes of the silica particles from the underflow. Further, the one or more cyclonic separating arrangements 205 recover one or more recovered ore extract mix (as illustrated in detailed description of FIG. 2B and FIG. 3B) and performs the de-watering of the one or more recovered ore extract mix to extract the one or more quantities of recovered ore by utilizing the one or more flocculants 210 and a second de-watering arrangement. The water tank 140 collects the washing fluid from the one or more cyclonic separating arrangements 205. The washing fluid collected in the water tank 140 can be used in the scrubbing and the screening of the ore 110.

The sludge having the silica particles is disposed off from the one or more cyclonic separating arrangements 205 into the ore residue disposal pond 145. A recovered ore extract mix from the one or more recovered ore extract mix passes from a cyclonic separating arrangement of the one or more cyclonic separating arrangements 205 to the one or more filter press arrangements 215. The one or more filter press arrangements 215 perform the pressure filtration on a recovered ore extract mix of the one or more recovered ore extract mix received from the cyclonic separating arrangement of the one or more cyclonic separating arrangements 205. In addition, the one or more filter press arrangements 215 recover a second quantity of recovered ore. The second quantity of recovered ore is re-slurred with caustic liquor in the re-slurring arrangement 150. The re-slurring arrangement 150 passes the second quantity of recovered ore to the pre-desilication tank 155 where it is stored. In an embodiment of the present disclosure, size of the ore particles of the recovered ore extract mix is in a range of 0.5 millimeter to 10 microns.

It may be noted that in FIG. 2A, the re-slurring arrangement 150 is utilized for re-slurring the second quantity of recovered ore with the caustic liquor; however those skilled in the art would appreciate that more number of re-slurring arrangements can be utilized for re-slurring the second quantity of recovered ore with the caustic liquor.

FIG. 2B illustrates various functional components of the beneficiation arrangement 105 in detail, in accordance with an embodiment of the present disclosure. It may be noted that to explain the functional elements of FIG. 2B, references will be made to the functional elements of FIG. 1 and FIG. 2A. The FIG. 2B includes a scrubber 220, an evoscreen 225, an evowash system 230, a primary cyclone 235, a secondary cyclone 240, a first thickening arrangement 245, a second thickening arrangement 250, a buffer tank 255, a filter press 260 and a filter press conveyor 265. Further, the scrubber 220 includes a vibratory screen 270 and a log washer 275. In an embodiment of the present disclosure, the evoscreen 225 is a functional component of the one or more screening arrangement 125. In another embodiment of the present disclosure, the evowash system 230, the primary cyclone 235, the secondary cyclone 240, the first thickening arrangement 245, the second thickening arrangement 250 and the buffer tank 255 are functional components of the one or more cyclonic separating arrangements 205. In yet another embodiment of the present disclosure, the filter press 260 and the filter press conveyor 265 are functional components of the one or more filter press arrangements 215.

The vibratory screen 270 receives the ore 110 through a ball mill feed conveyor. In an embodiment of the present disclosure, the ore 110 has particle size in a range of 40 millimeters to 25 millimeters. The vibratory screen 270 separates particles having size+3 millimeters from the ore 110. Moreover, the vibratory screen 270 is associated with a high pressure water jet system to wash the ore 110 and ensure proper washing of the particles of the ore 110. The log washer 275 collects oversized particles (+3 millimeters) of the ore 110 from the vibratory screen 270. The log washer 275 performs scrubbing of the oversized particles (+3 millimeters) with the washing fluid to remove the surface silica present in the ore 110. The evoscreen 225 collects the scrubbed ore from the log washer 275. The evoscreen 225 performs washing followed by the de-watering and moisture reduction of the scrubbed ore to extract the first quantity of recovered ore.

The first quantity of recovered ore containing the oversized particles having size of +3 millimeters passes from the evoscreen 225 to the one or more grinding arrangements 130 through the ball mill feed conveyor. The one or more grinding arrangements 130 include ball mills and perform the wet grinding of the first quantity of recovered ore. The wet grinding involves grinding the first quantity of recovered ore along with the caustic liquor. In addition, the one or more grinding arrangements 130 reduce size of the first quantity of recovered ore from 40-25 millimeters to 1.2 millimeters. Further, the grinded first quantity of recovered ore is fed to the pre-desilication tank 155.

However, the particles of the ore 110 having size smaller than 3 millimeters passing from an underflow of the vibratory screen 270 and the evoscreen 225 includes rich silica particles and are treated to improve overall yield. The evowash system 230 collects the rich silica particles having size smaller than 3 millimeters from the underflow of the vibratory screen 270 and the evoscreen 225. In an embodiment of the present disclosure, the evowash system 230 includes one or more sump pumps, one or more de-watering screens of a first de-watering arrangement and one or more hydro-cyclones. The evowash system 230 pumps rich silica particles of size smaller than 3 millimeters to the primary cyclone 235 through the one or more sump pumps. The primary cyclone 235 removes ultra-fine silica particles (particles with size smaller than 45 microns) from the particles of size smaller than 3 millimeters. The particles with size in a range of −3 millimeters to 45 microns passes from an underflow of the primary cyclone 235 to the evowash system 230 for performing the de-watering through the one or more de-watering screens of the first de-watering arrangement to extract a third quantity of recovered ore. Further, the third quantity of recovered ore passes from the evowash system 230 to the one or more grinding arrangements 130 for performing the wet grinding which reduces size of the third quantity of recovered ore from 3 millimeters to 1.2 millimeters.

However, an overflow of the primary cyclone 235 containing ore having the silica particles of size smaller than 45 microns goes to the secondary cyclone 240. Further, the secondary cyclone 240 classifies the ore particles based on size. The first thickening arrangement 245 collects the particles having size in a range of −45 microns to 10 microns from an underflow of the secondary cyclone 240 to increase density of the ore particles before feeding in the filter press 260. An underflow of the first thickening arrangement 245 passes the ore particles to the buffer tank 255. Further, the buffer tank 255 passes the ore particles to the filter press 260. The filter press 260 performs the pressure filtration on the ore particles to generate the second quantity of recovered ore. The second quantity of recovered ore passes from the filter press 260 to the re-slurring arrangement 150 through the filter press conveyor 265. Furthermore, the second quantity of recovered ore is re-slurred with the caustic liquor in the re-slurring arrangement 150 and fed to the pre-desilication tank 155.

However, the second thickening arrangement 250 collects an overflow of the secondary cyclone 240 for water recovery. The water tank 140 collects an overflow from the first thickening arrangement 245 and the second thickening arrangement 250 for re-circulation of the water back into the beneficiation arrangement 105. The water collected in the water tank 140 can be used in the scrubbing and the screening of the ore 110. In an embodiment of the present disclosure, the one or more flocculants 210 are added to the first thickening arrangement 245 and the second thickening arrangement 250 for performing the de-watering of the ore particles collected in the first thickening arrangement 245 and the second thickening arrangement 250. Examples of the one or more flocculants 210 include but may not be limited to sodium dialkyl sulfosuccinates, polyalkoxylated amines, modified lipids and the like. The sludge from an underflow of the second thickening arrangement 250 is disposed off in the ore residue disposal pond 145.

It may also be noted that in FIG. 2B, the water tank 140 stores the water; however those skilled in the art would appreciate that more number of water tanks can be utilized for storing the water.

FIG. 3A illustrates functional components of the beneficiation arrangement 105, in accordance with another embodiment of the present disclosure. It may be noted that to explain functional elements of FIG. 3A, references will be made to the functional elements of FIG. 1, FIG. 2A and FIG. 2B. The FIG. 3A includes a first scrubbing arrangement 305, a first screening arrangement 310, a first quantity of recovered ore 315, a first cyclonic separating arrangement 320 and a second quantity of recovered ore 325.

The first scrubbing arrangement 305 of the one or more scrubbing arrangements 120 receives the ore 110. In an embodiment of the present disclosure, particles of the ore 110 have size smaller than 40 millimeters. The first scrubbing arrangement 305 scrubs the ore 110 with the stream of washing fluid to liberate the fine silica particles attached with the ore 110. The scrubbed ore is subjected to screening and de-watering in the first screening arrangement 310 of the one or more screening arrangements 125 to extract the first quantity of recovered ore 315 and an underflow.

The first cyclonic separating arrangements 320 of the one or more cyclonic separating arrangements 205 collects the underflow of the first screening arrangement 310 having the fine ore slurry containing the higher silica content of size −0.5 millimeters. Further, the first cyclonic separating arrangements 320 separates the fine ore slurry into one or more ranges of sizes of the silica particles from the underflow to recover one or more recovered ore extract mix. In an embodiment of the present disclosure, size of the ore particles in the underflow is smaller than 0.5 millimeters. The water tank 140 collects the water from the first cyclonic separating arrangements 320. The water collected in the water tank 140 can be used in the scrubbing and the screening of the ore 110. Moreover, the ore residue disposal pond 145 collects an overflow of the first cyclonic separating arrangements 320.

The filter press 260 collects a recovered ore extract mix of the one or more recovered ore extract mix. Further, the filter press 260 performs pressure filtration on the collected recovered ore extract mix to recover the second quantity of recovered ore 325. Furthermore, the filter press 260 discharges an ore cake to the re-slurring arrangement 150 using a belt conveyor. In the re-slurring arrangement 150, the caustic liquor is added to form slurry of required density to generate the second quantity of recovered ore 325. In an embodiment of the present disclosure, the density of the slurry prepared in the re-slurring arrangement 150 is measured online by a density meter and a feedback from the density meter controls opening percentage of control valve in caustic addition line. The second quantity of recovered ore 325 passes to the pre-desilication tank 155.

It may be noted that in FIG. 3A, the first cyclonic separating arrangements 320 sends the water to the water tank 140; however those skilled in the art would appreciate that the first cyclonic separating arrangements 320 may send the water to any other tank known in the art which is capable of collecting the water or any other fluid.

FIG. 3B illustrates functional components of the beneficiation arrangement 105 in detail, in accordance with another embodiment of the present disclosure. It may be noted that to explain functional elements of FIG. 3B, references will be made to the functional elements of FIG. 1, FIG. 2A, FIG. 2B and FIG. 3A. The FIG. 3B includes a drum scrubber 330, a primary classifying screen 335, a secondary classifying screen 340, a sump 345, a cyclone 350, a tank 355 and a tailing thickener 360. In an embodiment of the present disclosure, the drum scrubber 330 is a functional component of the first scrubbing arrangement 305. In another embodiment of the present disclosure, the primary classifying screen 335 and the secondary classifying screen 340 are functional components of the first screening arrangement 310. In yet another embodiment of the present disclosure, the sump 345, the cyclone 350, the tank 355 and the tailing thickener 360 are functional components of the first cyclonic separating arrangements 320.

The drum scrubber 330 receives the ore 110. In an embodiment of the present disclosure, particles of the ore 110 have size smaller than 40 millimeters. The drum scrubber 330 scrubs the ore 110 with the stream of the washing fluid to liberate the fine silica particles attached with the ore 110. The scrubbed ore is subjected to the screening and the de-watering in the first screening arrangement 310 to extract the first quantity of recovered ore 315 and an underflow. The primary classifying screen 335 is a single deck screen performing the screening and the de-watering of the scrubbed ore at 20 millimeters particle size. The primary classifying screen 335 discharges oversized particles of size in a range of −40 millimeters to +20 millimeters on a conveyor belt and undersize particles having size below 20 millimeters to the secondary classifying screen 340. The secondary classifying screen 340 is a single deck screen that carries particle size separation at 0.5 millimeters.

The secondary classifying screen 340 discharges oversized particles in a range of −20 millimeters to 0.5 millimeters on the same conveyor belt as the primary classifying screen 335 and an underflow of size −0.5 millimeters with fine ore slurry containing the higher silica content. The oversized particles of size −40 millimeters to +20 millimeters from the primary classifying screen 335 and the oversized particles of size −20 millimeters to 0.5 millimeters from the secondary classifying screen 340 collectively forms the first quantity of recovered ore 315. The size separation of the silica particles extracts one or more quantities of recovered ore.

The sump 345 collects the underflow of the secondary classifying screen 340 having the fine ore slurry containing the higher silica content of size −0.5 millimeters. The sump 345 is any low space that collects desirable/undesirable liquids including water, chemicals and the like. The sump 345 includes a sump pump that pumps the fine ore slurry containing the higher silica content to the cyclone 350 at a suitable pressure. The cyclone 350 separates the fine ore slurry into the one or more ranges of the sizes of the silica particles from the underflow to recover one or more recovered ore extract mix. In an embodiment of the present disclosure, the size of ore particles in the underflow is smaller than 0.5 millimeters.

The tailing thickener 360 collects an overflow of the cyclone 350 having particles with the high silica content and size up to 10 microns. The tailing thickener 360 maximizes water recovery by using one or more paste thickeners. The water tank 140 collects an overflow of the tailing thickener 360 that contains the water. The water collected in the water tank 140 can be used in the scrubbing and the screening of the ore 110. In an embodiment of the present disclosure, the overflow of the tailing thickener 360 may be collected in the water tank 140 or any other tank capable of collecting the water or the washing fluid and pumping it back to a beneficiation plant for re-use. The sump 345 collects an underflow of the tailing thickener 360 and pumps the underflow to a last washer which sends the overflow to the ore residue disposal pond 145.

However, the tank 355 collects an underflow of the cyclone 350 having required solid content and passes the underflow to the filter press 260. The filter press 260 performs the pressure filtration on a recovered ore extract mix of the one or more recovered ore extract mix to recover the second quantity of recovered ore 325. In an embodiment of the present disclosure, a filter feed tank with agitator collects the underflow of the cyclone 350 and passes the underflow to the filter press 260. In addition, the press filter 260 generates a filtrate and passes it to a tank. Further, the tank pumps the filtrate to the tailing thickener 360 which passes the filtrate to a thickener overflow tank. In an embodiment of the present disclosure, the filtrate may be passed to the tailing thickener 360 or any other thickener/tank known in the art which is capable of collecting the filtrate. Further, the filter press 260 discharges an ore cake to the re-slurring arrangement 150 using a belt conveyor. In the re-slurring arrangement 150, the caustic liquor is added to the ore cake to form slurry of required density to generate the second quantity of recovered ore 325. In an embodiment of the present disclosure, the density of the slurry prepared in the re-slurring arrangement 150 is measured online by a density meter and a feedback from the density meter controls opening percentage of control valve in caustic addition line. The second quantity of recovered ore 325 passes to the pre-desilication tank 155.

In an embodiment of the present disclosure, size of ore particles of the recovered ore extract mix is in a range of 0.5 millimeters to 10 microns. In another embodiment of the present disclosure, the first quantity of recovered ore 315 and the one or more quantities of recovered ore is in a range of 88-95 percent of the ore 110 and the silica content separated from the ore 110 is in a range of 20-50 percent. In yet another embodiment of the present disclosure, the first cyclonic separating arrangements 320 produces a mixture including a pre-determined range of size of the silica particles and the silica particles of the pre-determined range of size are recovered from the mixture by utilizing bio-leaching. The bio-leaching extracts metals from their ores by action of living organisms.

In yet another embodiment of the present disclosure, the first scrubbing arrangement 305 and the first screening arrangement 310 extract the first quantity of recovered ore 315 having size in a range of 40-20 millimeters to +0.5 millimeters.

It may be noted that in FIG. 3B, the cyclone 350 separates the fine ore slurry into the one or more ranges of the sizes of the silica particles from the underflow to recover the one or more recovered ore extract mix; however those skilled in the art would appreciate that more number of cyclones may be utilized for the separation. It may also be noted that in FIG. 3B, the tailing thickener 360 collects the overflow of the cyclone 350; however those skilled in the art would appreciate that more number of tailing thickeners may be utilized for collecting the overflow of the cyclone 350.

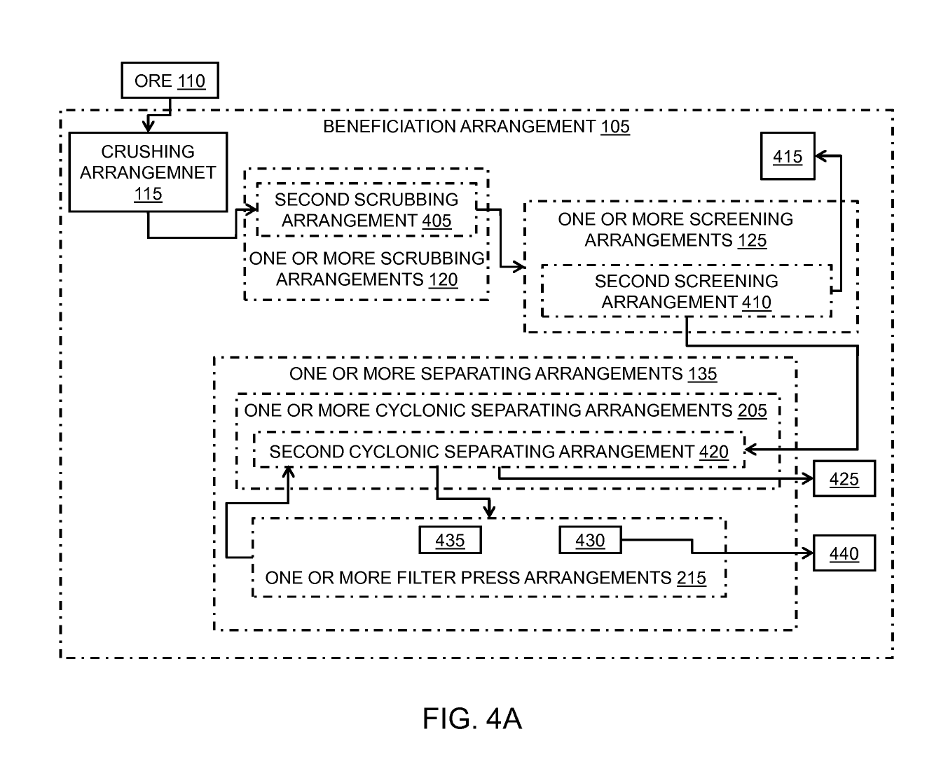

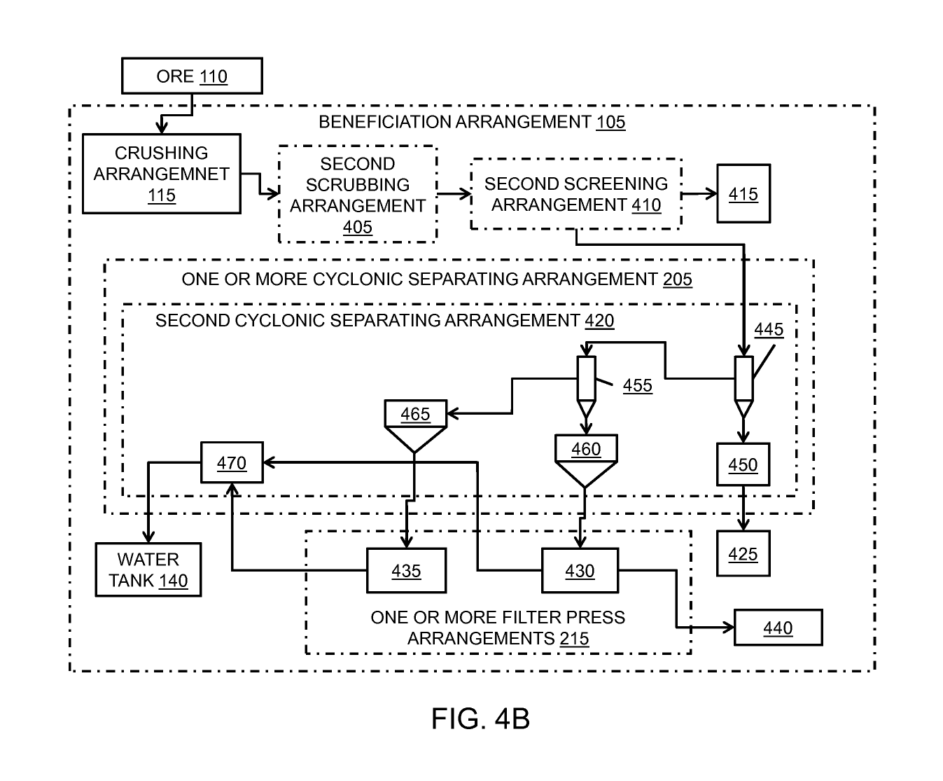

FIG. 4A illustrates functional components of the beneficiation arrangement 105, in accordance with yet another embodiment of the present disclosure. It may be noted that to explain the functional elements of FIG. 4A, references will be made to the functional elements of FIG. 1, FIG. 2A, FIG. 2B, FIG. 3A and FIG. 3B. The FIG. 4A includes a second scrubbing arrangement 405, a second screening arrangement 410, a first quantity of recovered ore 415, a second cyclonic separating arrangement 420, a third quantity of recovered ore 425, a first filter press 430, a second filter press 435 and a second quantity of recovered ore 440.

The crushing arrangement 115 crushes the ore 110 to produce the crushed ore having particles of size in a range of 25 millimeters. The second scrubbing arrangement 405 scrubs the crushed ore with the stream of the washing fluid. In an embodiment of the present disclosure, the second scrubbing arrangement 405 may be the scrubber 220, the log washer 275 or any other scrubbing apparatus known in the art which is capable of scrubbing the crushed ore. Going further, the second screening arrangement 410 performs screening of the scrubbed ore with high pressure water washing followed by the de-watering of the screened ore to extract the first quantity of recovered ore 415 and an underflow. In another embodiment of the present disclosure, the first quantity of recovered ore 415 has particles of size in range of −25 millimeters to +3 millimeters.

The one or more separating arrangements 135 facilitates separation of the at least silica particles from the underflow of the second screening arrangement 410 having size in a range of −3 millimeters. Further, the one or more cyclonic separating arrangements 205 separates the silica particles into one or more ranges of sizes of the silica particles from the underflow to recover one or more recovered ore extract mix. The second cyclonic separating arrangement 420 of the one or more cyclonic separating arrangements 205 extracts the third quantity of recovered ore 425. Going further, the one or more filter press arrangements 215 receives a recovered ore extract mix of the one or more recovered ore extract mix from the second cyclonic separating arrangement 420. The first filter press 430 of the one or more filter press arrangements 215 performs the pressure filtration of the received recovered ore extract mix to extract the second quantity of recovered ore 440.

Going further, the second filter press 435 performs the pressure filtration of the ore particles to produce a pre-determined range of size of the silica particles and the silica particles of the pre-determined range of size is recovered by utilizing the bio-leaching (as illustrated in detailed description of FIG. 3B).

In an embodiment of the present disclosure, size of the first quantity of recovered ore 415 is in a range of −25 millimeters to +3 millimeters, size of the second quantity of recovered ore 440 is in a range of −45 microns to +10 microns and size of the third quantity of recovered ore 425 is in a range of −3 millimeters to +45 microns. In another embodiment of the present disclosure, a moisture content in the first quantity of recovered ore 415 is in a range of 6 percent to 10 percent, a moisture content in the second quantity of recovered ore 440 is in a range of 10 percent to 15 percent and a moisture content in the third quantity of recovered ore 425 is in a range of 20 percent to 25 percent.

In yet another embodiment of the present disclosure, a weight of the ore particles in the first quantity of recovered ore 415 is 82 percent to 84 percent, a weight of the ore particles in the second quantity of recovered ore 440 is 4 percent to 6 percent, a weight of the ore particles in the third quantity of recovered ore 425 is 6 percent to 8 percent and a weight of the thickened ore particles producing the pre-determined range of size of silica particles is 5 percent to 8 percent.

It may be noted that in FIG. 4A, the first filter press 430 and the second filter press 435 are utilized for performing the pressure filtration on the recovered ore extract mix; however those skilled in the art would appreciate that more/less number of filter press may be utilized to perform the pressure filtration on the recovered ore extract mix.

FIG. 4B illustrates functional components of the beneficiation arrangement 105 in detail, in accordance with yet another embodiment of the present disclosure. It may be noted that to explain the functional elements of FIG. 4B, references will be made to the functional elements of FIG. 1, FIG. 2A, FIG. 2B, FIG. 3A, FIG. 3B and FIG. 4A. The FIG. 4B includes a first cyclone 445, a de-watering screen 450 of the first de-watering arrangement, a second cyclone 455, a first thickening arrangement 460, a second thickening arrangement 465 and a filtrate collecting arrangement 470. In an embodiment of the present disclosure, the first cyclone 445, the de-watering screen 450, the second cyclone 455, the first thickening arrangement 460, the second thickening arrangement 465 and the filtrate collecting arrangement 470 are functional components of the second cyclonic separating arrangement 420. In another embodiment of the present disclosure, the first filter press 430 and the second filter press 435 are functional components of the one or more filter press arrangement 215. In yet another embodiment of the present disclosure, the ore 110 has particles having size in a range of 40 millimeters to 150 millimeters.

The crushing arrangement 115 crushes the ore 110 to produce the crushed ore having particles of size in a range of 25 millimeters. The second scrubbing arrangement 405 scrubs the crushed ore with the stream of the washing fluid. In an embodiment of the present disclosure, the second scrubbing arrangement 405 may be the scrubber 220, the log washer 275 or any other scrubbing apparatus known in the art which is capable of scrubbing the crushed ore. Going further, the second screening arrangement 410 performs screening of the scrubbed ore with the high pressure water washing followed by the de-watering of the screened ore to extract the first quantity of recovered ore 415 and the underflow. In an embodiment of the present disclosure, the second screening arrangement 410 includes double deck de-watering screens for performing the screening with the high pressure water washing followed by the de-watering of the screened ore. In another embodiment of the present disclosure, the first quantity of recovered ore 415 has particles of size in range of −25 millimeters to +3 millimeters.

The second cyclonic separating arrangement 420 facilitates separation of the at least silica particles from the underflow of the second screening arrangement 410 having size in a range of −3 millimeters. Further, the second cyclonic separating arrangement 420 separates the silica particles into the one or more ranges of the sizes of the silica particles from the underflow to recover the one or more recovered ore extract mix. The first cyclone 445 separates the silica particles from the underflow to extract a recovered ore extract mix of the one or more recovered ore extract mix. The de-watering screen 450 of the first de-watering arrangement performs the de-watering of the recovered ore extract mix of the one or more recovered ore extract mix to recover the third quantity of recovered ore 425.

The second cyclone 455 receives an overflow of the first cyclone 445 containing finer ore particles with the high silica content of size in a range of −45 microns. The second cyclone 455 separates the finer ore particles with the high silica content from the overflow of the first cyclone 445 to extract another recovered ore extract mix of the one or more recovered ore extract mix. The first thickening arrangement 460 agitates or increases density of the extracted recovered ore extract mix using one or more thickening agents. Going further, the first filter press 430 performs the pressure filtration of the thickened recovered ore extract mix to extract the second quantity of recovered ore 440.

Moreover, the second thickening arrangement 465 collects an overflow of the second cyclone 455 having the ore particles of size in a range of −10 microns and performs thickening of the ore particles of size in the range of −10 microns using the one or more thickening agents. Going further, the second filter press 435 performs the pressure filtration of the thickened ore particles to produce the pre-determined range of size of the silica particles and the silica particles of the pre-determined range of size is recovered by utilizing the bio-leaching (as illustrated in detailed description of FIG. 3B). In addition, the first filter press 430 and the second filter press 435 generates the filtrate. The filtrate collecting arrangement 470 collects the filtrate from the first filter press 430 and the second filter press 435 and sends it to the water tank 140. The water collected in the water tank 140 can be used in the scrubbing and the screening of the ore 110.

In an embodiment of the present disclosure, size of the first quantity of recovered ore 415 is in a range of −25 millimeters to +3 millimeters, size of the second quantity of recovered ore 440 is in a range of −45 microns to +10 microns and size of the third quantity of recovered ore 425 is in a range of −3 millimeters to +45 microns.

In another embodiment of the present disclosure, a moisture content in the first quantity of recovered ore 415 is in a range of 6 percent to 10 percent, a moisture content in the second quantity of recovered ore 440 is in a range of 10 percent to 15 percent and a moisture content in the third quantity of recovered ore 425 is in a range of 20 percent to 25 percent.

In yet another embodiment of the present disclosure, a weight of the ore particles in the first quantity of recovered ore 415 is 82 percent to 84 percent, a weight of the ore particles in the second quantity of recovered ore 440 is 4 percent to 6 percent, a weight of the ore particles in the third quantity of recovered ore 425 is 6 percent to 8 percent and a weight of the thickened ore particles producing the pre-determined range of size of silica particles is 5 percent to 8 percent.

It may be noted that in FIG. 4B, the de-watering screen 450 performs the de-watering of the recovered ore extract mix; however those skilled in the art would appreciate that more number of de-watering screens may be utilized to perform the de-watering of the recovered ore extract mix.

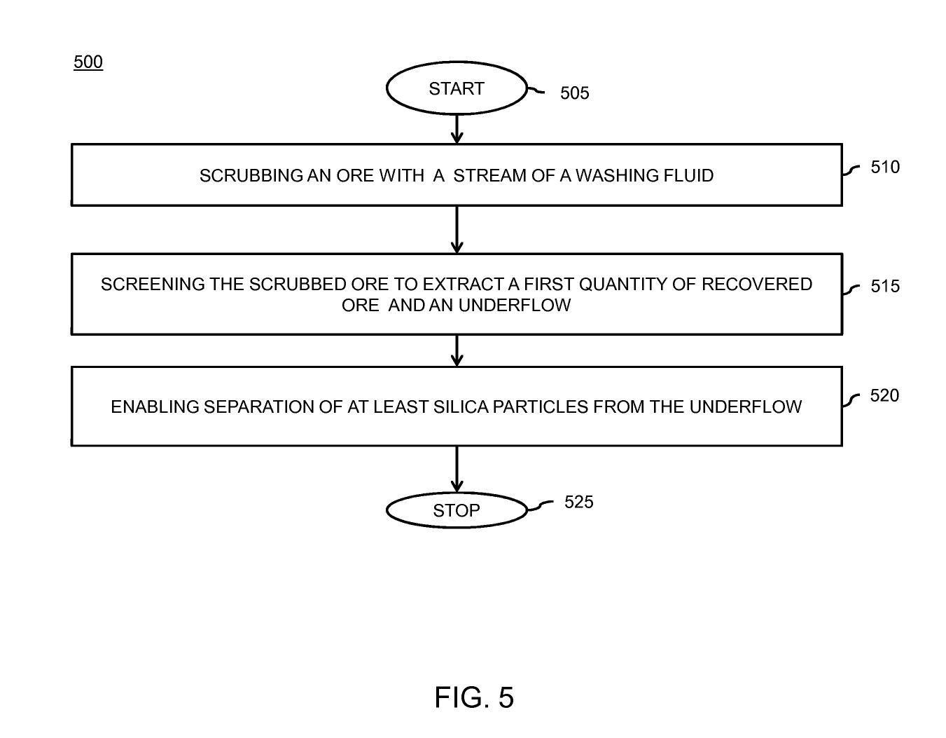

FIG. 5 illustrates a flowchart 500 for removing the silica from the ore, in accordance with an embodiment of the present disclosure. It may be noted that to explain the process steps of FIG. 5, references will be made to the functional elements of FIG. 1, FIG. 2A, FIG. 2B, FIG. 3A, FIG. 3B, FIG. 4A and FIG. 4B. The flowchart 500 initiates at step 505. Following step 505, at step 510, the one or more scrubbing arrangements 120 scrubs the ore with the stream of the washing fluid. The ore is one of the bauxite or the laterite. At step 515, the one or more screening arrangements 125 perform screening of the scrubbed ore to extract a first quantity of recovered ore and the underflow. In an embodiment of the present disclosure, the first quantity of recovered ore may include but not be limited to the first quantity of recovered ore 315 or the first quantity of recovered ore 415. At step 520, the one or more separating arrangements 135 enables separation of the at least silica particles from the underflow. The flowchart 500 terminates at step 525.

It may be noted that the flowchart 500 is explained to have above stated process steps; however, those skilled in the art would appreciate that the flowchart 500 may have more/less number of process steps which may enable all the above stated embodiments of the present disclosure.

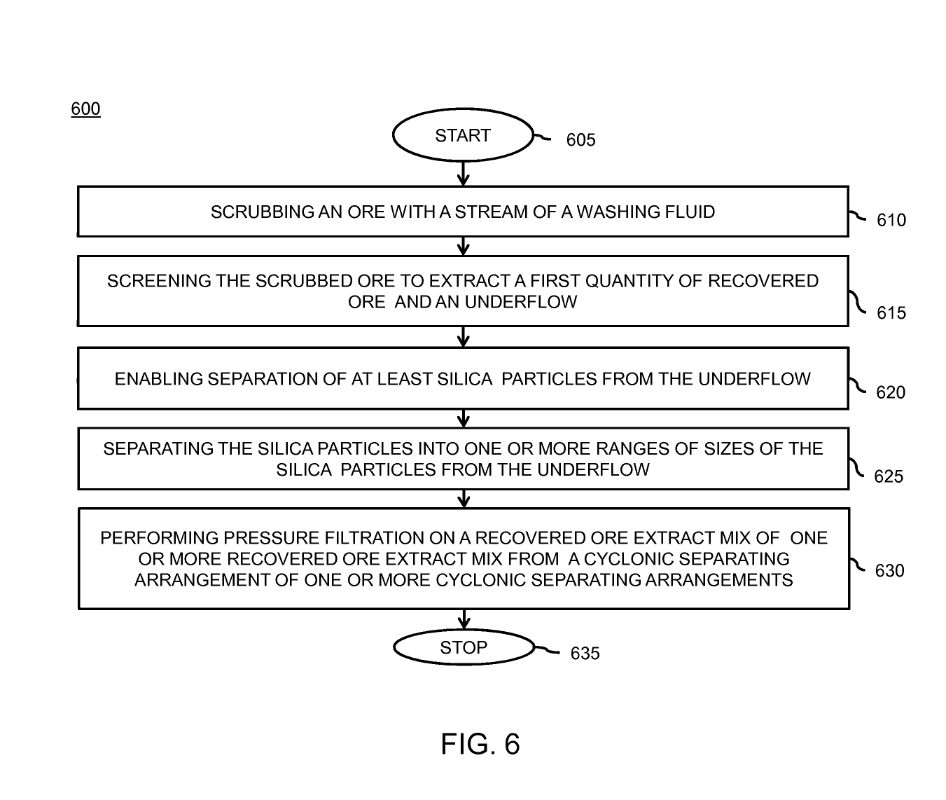

FIG. 6 illustrates a flowchart 600 for facilitating the separation of the silica particles from the underflow, in accordance with the embodiment of the present disclosure. It may be noted that to explain the process steps of FIG. 6, references will be made to the functional elements of FIG. 1, FIG. 2A, FIG. 2B, FIG. 3A, FIG. 3B, FIG. 4A and FIG. 4B and the process steps of FIG. 5. The flowchart 600 initiates at step 605. Following step 605, at step 610, the one or more scrubbing arrangements 120 scrubs the ore with the stream of the washing fluid. The ore is one of the bauxite or the laterite. At step 615, the one or more screening arrangements 125 perform screening of the scrubbed ore to extract the first quantity of recovered ore and the underflow. At step 620, the one or more separating arrangements 135 enables the separation of the at least silica particles from the underflow. The separation of the at least silica particles from the underflow is explained by the process steps 625 and 630. At step 625, the one or more cyclonic separating arrangements 205 cyclonically separate the silica particles into the one or more ranges of sizes of the silica particles from the underflow. At step 630, the one or more filter press arrangements 215 performs the pressure filtration on the recovered ore extract mix of the one or more recovered ore extract mix from a cyclonic separating arrangement of the one or more cyclonic separating arrangements 205. Following steps 625 and 630, the flowchart 600 terminates at step 635.

It may be noted that the flowchart 600 is explained to have above stated process steps; however, those skilled in the art would appreciate that the flowchart 600 may have more/less number of process steps which may enable all the above stated embodiments of the present disclosure.

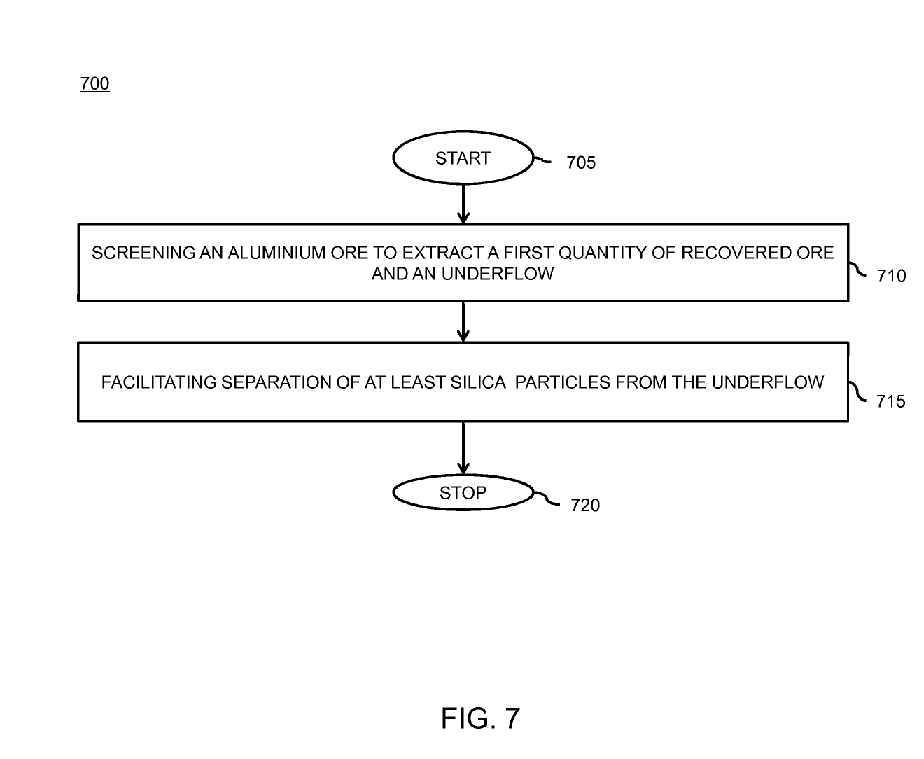

FIG. 7 illustrates a flowchart 700 for removing the silica from the ore, in accordance with another embodiment of the present disclosure. It may be noted that to explain the process steps of FIG. 7, references will be made to the functional elements of FIG. 1, FIG. 2A, FIG. 2B, FIG. 3A, FIG. 3B, FIG. 4A and FIG. 4B and process steps of FIG. 5 and FIG. 6. The flowchart 700 initiates at step 705. Following step 705, at step 710, the one or more screening arrangements 125 perform screening of an aluminium ore to extract the first quantity of recovered ore and the underflow. At step 715, the one or more separating arrangements 135 facilitates the separation of the at least silica particles from the underflow. The flowchart 700 terminates at step 720.

It may be noted that the flowchart 700 is explained to have above stated process steps; however, those skilled in the art would appreciate that the flowchart 700 may have more/less number of process steps which may enable all the above stated embodiments of the present disclosure.

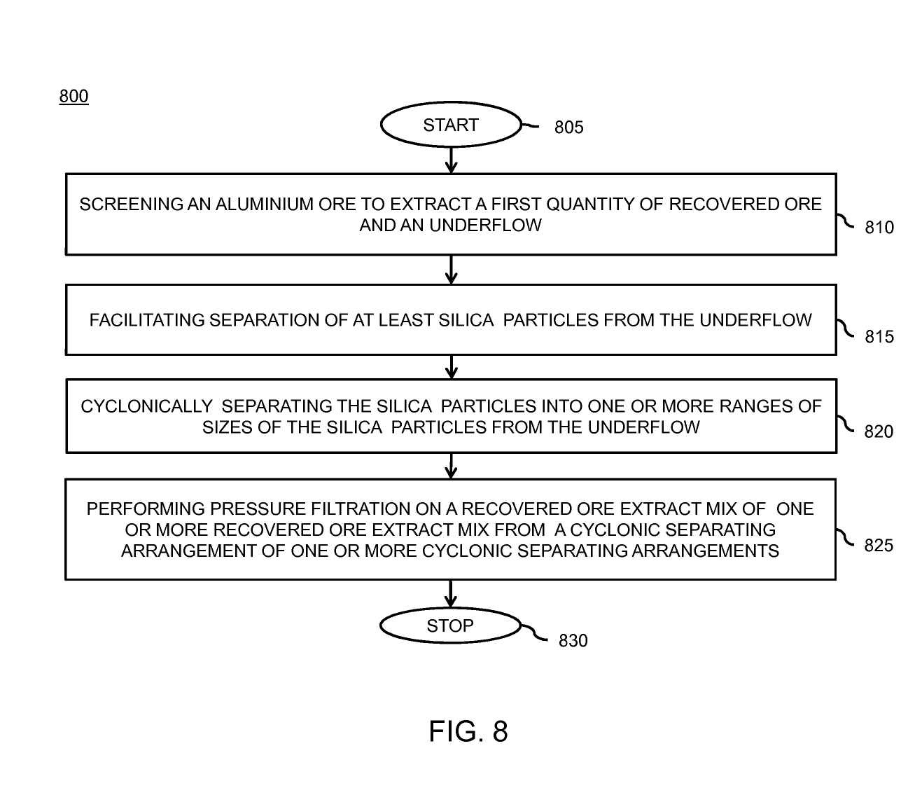

FIG. 8 illustrates a flowchart 800 for facilitating the separation of the silica particles from the underflow, in accordance with another embodiment of the present disclosure. It may be noted that to explain the process steps of FIG. 8, references will be made to the functional elements of FIG. 1, FIG. 2A, FIG. 2B, FIG. 3A, FIG. 3B, FIG. 4A and FIG. 4B and the process steps of FIG. 5, FIG. 6 and FIG. 7. The flowchart 800 initiates at step 805. Following step 805, at step 810, the one or more screening arrangements 125 perform screening of the aluminium ore to extract the first quantity of recovered ore and the underflow. At step 815, the one or more separating arrangements 135 facilitates the separation of the at least silica particles from the underflow. The separation of the at least silica particles from the underflow is explained by the process steps 820 and 825. At step 820, the one or more cyclonic separating arrangements 205 cyclonically separate the silica particles into the one or more ranges of sizes of the silica particles from the underflow. At step 825, the one or more filter press arrangements 215 performs the pressure filtration on the recovered ore extract mix of the one or more recovered ore extract mix from a cyclonic separating arrangement of the one or more cyclonic separating arrangements 205. Following steps 820 and 825, the flowchart 800 terminates at step 830.

It may be noted that the flowchart 800 is explained to have above stated process steps; however, those skilled in the art would appreciate that the flowchart 800 may have more/less number of process steps which may enable all the above stated embodiments of the present disclosure.

The above stated methods and system have many advantages. The above stated methods and system provides beneficiation of low grade ores with 10 percent reduction in caustic consumption due to reduction in the silica content in the ore. Further, the above stated methods and system reduces cost of production, recovers the ore in a range of 90 percent to 95 percent and reduces silica in a range of 20 percent to 50 percent. Furthermore, the high silica rejects can be treated in the bioleaching of the silica which can facilitate utilization of the ore without any rejects. In addition, the above stated methods and system reduces in-scale formation in tanks, equipments, heat exchangers and other structural components which enables easier maintenance and reduction in de-scaling activities. Moreover, the above stated methods and system maintains quality of the extracted ore having quantity of the silica particles within the limits.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A beneficiation arrangement for removing silica from an ore, said beneficiation arrangement comprising:
one or more scrubbing arrangements, wherein said one or more scrubbing arrangements is operationally adapted to scrub said ore with a stream of a washing fluid, and wherein one or more scrubbing arrangements is operationally adapted to recover said silica from said ore;
one or more screening arrangements, wherein said one or more screening arrangements is operationally adapted to perform screening of said scrubbed ore to extract a first quantity of recovered ore and an underflow; and wherein said first quantity of recovered ore is in a range of 88-95 percent of said ore; and
one or more separating arrangements, wherein said one or more separating arrangements is operationally adapted to enable separation of at least silica particles from said underflow, wherein said one or more separating arrangements extracts one or more quantities of recovered ore in said range of 88-95 percent of said ore, wherein said one or more separating arrangements comprises:
one or more cyclonic separating arrangements, wherein said one or more cyclonic separating arrangements are operationally adapted to cyclonically separate said silica particles into one or more ranges of sizes of said silica particles from said underflow, wherein said one or more cyclonic separating arrangements are operationally adapted to recover one or more recovered ore extract mix, and wherein size of said ore particles in said underflow is in a range of −3 millimeters to 0.5 millimeters; and
one or more filter press arrangements, wherein said one or more filter press arrangements are operationally adapted to perform pressure filtration on a recovered ore extract mix of said one or more recovered ore extract mix received from a cyclonic separating arrangement of said one or more cyclonic separating arrangements, wherein said one or more filter press arrangements are operationally adapted to recover a second quantity of recovered ore by said performing of said pressure filtration on said recovered ore extract mix, and wherein size of said ore particles of said recovered ore extract mix is in a range of 0.5 millimeters to 10 microns.

2. The beneficiation arrangement as recited in claim 1, further comprising a first de-watering arrangement, wherein said first de-watering arrangement is operationally adapted to perform de-watering of a recovered ore extract mix of said one or more recovered ore extract mix from a cyclonic separating arrangement of said one or more cyclonic separating arrangements, and wherein said first de-watering arrangement recovers a third quantity of recovered ore.

3. The beneficiation arrangement as recited in claim 1, wherein said one or more cyclonic separating arrangements is further adapted to produce a mixture including a pre-determined range of size of silica particles, wherein said silica particles of said pre-determined range of size being recovered from said mixture by utilizing bio-leaching.

4. The beneficiation arrangement as recited in claim 1, further comprising a re-slurring arrangement, and wherein said re-slurring arrangement is operationally adapted to perform re-slurring of said second quantity of recovered ore with caustic liquor.

5. The beneficiation arrangement as recited in claim 1, further comprising one or more grinding arrangements, said one or more grinding arrangements are operationally adapted to grind said first quantity of recovered ore and said third quantity of recovered ore with said caustic liquor, and wherein said one or more grinding arrangements are operationally adapted to reduce size of said first quantity of recovered ore from 40-25 millimeters to 1.2 millimeters and size of said third quantity of recovered ore from 3 millimeters to 1.2 millimeters.

6. The beneficiation arrangement as recited in claim 1, wherein a first scrubbing arrangement of said one or more scrubbing arrangements and a first screening arrangement of said one or more screening arrangements are operationally adapted to extract said first quantity of recovered ore having size in a range of 40-20 millimeters to +0.5 millimeters.

7. The beneficiation arrangement as recited in claim 1, wherein a second scrubbing arrangement of said one or more scrubbing arrangements and a second screening arrangement of said one or more screening arrangements are operationally adapted to extract said first quantity of recovered ore, said second quantity of recovered ore having size in a range of −45 microns to +10 microns and said third quantity of recovered ore having size in a range of −3 millimeters to +45 microns.

8. The beneficiation arrangement as recited in claim 1, further comprising a filtrate collecting arrangement, and wherein said filtrate collecting arrangement is operationally adapted to collect a filtrate generated from said removal of said silica from said ore in said beneficiation arrangement.

9. The beneficiation arrangement as recited in claim 1, further comprising a second de-watering arrangement, and wherein said second de-watering arrangement is operationally adapted to perform de-watering of said one or more recovered ore extract mix to extract said one or more quantities of recovered ores.

10. The beneficiation arrangement as recited in claim 1, further comprising one or more thickening arrangements, and wherein said one or more thickening arrangements are operationally adapted to facilitate thickening of said one or more recovered ore extract mix to extract said one or more quantities of recovered ores.

11. A method for removing silica from an ore, said method comprising:
scrubbing said ore with a stream of a washing fluid, wherein said scrubbing is performed in a beneficiation arrangement to remove said silica;
screening said scrubbed ore to extract a first quantity of recovered ore and an underflow; and
enabling separation of at least silica particles from said underflow, wherein said separation of silica particles extracts one or more quantities of recovered ore, wherein said enabling comprises:
separating said silica particles into one or more ranges of sizes of said silica particles from said underflow, wherein said separating recovers one or more recovered ore extract mix by utilizing one or more cyclonic separating arrangements, and wherein size of said ore particles in said underflow is in a range of −3 millimeter to 0.5 millimeter; and
performing pressure filtration on a recovered ore extract mix of said one or more recovered ore extract mix from a cyclonic separating arrangement of said one or more cyclonic separating arrangements, wherein said performing of said pressure filtration on said recovered ore extract mix recovers a second quantity of recovered ore, and wherein size of ore particles of said recovered ore extract mix is in a range of 0.5 millimeter to 10 micron,
wherein said first quantity of recovered ore and said one or more quantities of recovered ore is in a range of 88-95 percent of said ore, and wherein said method reduces said silica in said ore in a range of 20-50 percent.

12. The method as recited in claim 11, further comprising de-watering a recovered ore extract mix of said one or more recovered ore extract mix from a cyclonic separating arrangement of said one or more cyclonic separating arrangements, wherein said de-watering of said recovered ore extract mix recovers a third quantity of recovered ore.

13. The method as recited in claim 11, wherein said scrubbing and said screening is performed to extract said first quantity of recovered ore having size in a range of 40-20 millimeters to +0.5 millimeters by utilizing a first scrubbing arrangement and a first screening arrangement.

14. The method as recited in claim 11, wherein said scrubbing and said screening is performed to extract said first quantity of recovered ore, said second quantity of recovered ore having size in a range of −45 microns to +10 microns and said third quantity of recovered ore having size in a range of −3 millimeters to +45 microns by utilizing a second scrubbing arrangement and a second screening arrangement.

15. The method as recited in claim 11, wherein a moisture content in said first quantity of recovered ore is in a range of 6 percent to 10 percent, a moisture content in said second quantity of recovered ore is in a range of 10 percent to 15 percent and a moisture content in said third quantity of recovered ore is in a range of 20 percent to 25 percent.

16. The method as recited in claim 11, further comprising performing de-watering of said one or more recovered ore extract mix to extract said one or more quantities of recovered ores.

17. A method for removing silica from an aluminium ore, said method comprising:
screening said aluminium ore to extract a first quantity of recovered ore and an underflow, wherein said aluminium ore is scrubbed with a stream of a washing fluid, and wherein said screening is performed in a beneficiation arrangement to remove said silica; and
facilitating separation of at least silica particles from said underflow, wherein said separation of silica particles extracts one or more quantities of recovered ore, and wherein said facilitating comprises:
cyclonically separating silica particles into one or more ranges of sizes of said silica particles from said underflow, wherein said cyclonically separating recovers one or more recovered ore extract mix by utilizing one or more cyclonic separating arrangements, and wherein size of said aluminium ore particles in said underflow is in a range of −3 millimeters to 0.5 millimeters; and
performing pressure filtration on a recovered ore extract mix of said one or more recovered ore extract mix from a cyclonic separating arrangement of said one or more cyclonic separating arrangements, wherein said performing of said pressure filtration on said recovered ore extract mix recovers a second quantity of recovered ore, and wherein size of said aluminium ore particles of said recovered ore extract mix is in a range of 0.5 millimeter to 10 micron,
wherein said first quantity of recovered ore and said one or more quantities of recovered ore is in a range of 88-95 percent of said aluminium ore, and wherein said method reduces said silica in said aluminium ore in a range of 20-50 percent.

18. The method as recited in claim 17, further comprising grinding said first quantity of recovered ore and said third quantity of recovered ore with a caustic liquor, wherein said grinding reduces size of said first quantity of recovered ore from 40-25 millimeters to 1.2 millimeters and size of said third quantity of recovered ore from 3 millimeters to 1.2 millimeters.

19. The method as recited in claim 17, further comprising collecting a filtrate generated from said removal of said silica from said aluminium ore in said beneficiation arrangement.

20. The method as recited in claim 17, wherein said aluminium ore being one of a bauxite and a laterite.
